(19) United States
(12) Patent Application Publication
(10) Pub. No.: US 2004/0103343 A1
(43) Pub. Date: May 27, 2004

(54) METHOD AND RELATED COMPUTER FOR PROCESSING SUSPEND TO RAM DURING POWER FAILURE

(76) Inventors: Wei-Jer Wu, Taipei Hsien (TW); Shih-Chin Lai, Taipei Hsien (TW); Jiann-Jou Chen, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,178

(22) Filed: Mar. 20, 2003

(30) Foreign Application Priority Data
Nov. 22, 2002 (TW) 091134122

(51) Int. Cl. H04L 1/22

(52) U.S. Cl. 714/14

(57) ABSTRACT

A method and related computer for processing suspend to RAM (STR) during power failure. The computer operates with power supplied by an external power source, and the computer includes a battery. When the computer stops receiving power from the external power source and stops operating, the battery will supply the power required for STR, such that when the computer again receives power from the external source, the computer will restore operation rapidly from STR.

### BACKGROUND OF INVENTION

1. Field of the Invention

The present invention relates to a method and related computer, and more specifically, to a method and related computer relied with power from a battery for sustaining data in the RAM during power failure so that the computer can rapidly resume operation once supplied the power from an external power source.

2. Description of the Prior Art

In modern information society, a computer has become the most vital tool for data processing and information access. How to make a computer more convenient and useful has become a main developing point to the information industry.

Please refer to FIG. 1. Illustrated in FIG. 1 is a functional block diagram of a prior art computer 10. The computer 10 comprises a processor 12 (CPU), a chipset 14, a variety of peripherals 18, a volatile RAM 32, a video card 34, a monitor 36, and an adaptor 40. The processor 12 is applied to control operations of the computer 10. Through a north bridge chipset 16A and a south bridge chipset 16B of the chipset 14, the processor 12 can command the RAM 32, the video card 34, and the peripherals 18 wherein the RAM 32 is applied to temporarily store related data for operating the processor 12. The video card 34 is applied to deal with image information and transfer the information to the monitor 36 for expressing the operational status of the computer 10. The peripherals 18 can be a storage device hard disk drive 22A, an optical disk drive 22B, or an input device acting as a man machine interface such as a keyboard 28 or a pointing device 24 (a mouse, or a touch pad). Through the chipset 14, the processor 12 can access the data stored in the hard disk drive 22A and the optical disk drive 22B. A plurality of keys 29 are provided on the keyboard 28, when a user pushes each of the key 29, an action will be converted to a corresponding operation signal 27 by a controller 26, and transmitted through a bus 20B and the chipset 14 to the processor 12 such that the processor 12 can operate according to commands of the user. Similarly, the action, caused by a user controlling the pointing device 24, can turn out to be a corresponding operation signal transmitted through the bus 20B and the chipset 14 to the processor 12. A BIOS (basic input/output system) 30 of the peripherals 18 stores some essential program code in a non-volatile manner. By executing such essential program code, the processor 12 can access signals of associated circuits of the peripherals 18. When turning on the computer 10, the processor 12 will execute the essential program code stored in the BIOS 30, perform a self-test, initiate each device and circuit of the computer 10, and load needed program code 38 (such as an operation system, or an application software) from a storage device (such as the hard disk drive 22A) to the RAM 32. By executing the program codes 38 in the RAM 32, the computer 10 can perform functions.

The adaptor 40 is applied to convert the power of an external power source 42 to one available for the computer 10 usually being a DC current with 5, 3.3, 2.5, or 1.25 V, supplying the processor 12, the chipset 14, the RAM 32, the video card 34, and peripherals 18 wherein in a desktop computer, the external power source 42 is an AC current. In a notebook computer, it can be a power storage device or an AC current.

Recently, a so-called desknote computer is being developed whose look is similar to that of a notebook computer, wherein the vital difference between them is that the desknote computer is supplied with power from an AC current but not a power storage device which enables a desknote computer to apply a high efficiency and low cost desktop computer structure (such as the computer 10 illustrated in FIG. 1), and reduce the occupied space and weight of a power storage device. Thus, a desknote computer has advantages of being highly portable, efficient and with low cost.

Certainly, without power supplied from a power storage device or an AC current, a desknote computer being moved from one place to another place has to be shut down until the desknote computer has moved to a target place and been supplied with power from an AC current again, and a user must then turn on the computer again to use the desknote computer. Additionally, once the external AC current is off (such as during a service interruption or when a power cord is removed), the prior art computer illustrated in FIG. 1 will no longer operate. Even if the computer 10 can regain power from an external power source, the computer has to be turned on again, and the complicated application software initiating processes have to be repeated. Generally, turning on a computer takes about several seconds to minutes, and initiation of application software takes even more time.

In fact, a prior art STR (suspend to RAM) has been applied for a computer entering into a holding operation status. After being relieved from the STR status, the computer can quickly resume to operate. It takes only 5 seconds from holding to recovering. The processes of STR applied in the prior art computer 10 in FIG. 1 can be expressed as follows. In operations of the computer 10, it will load needed program codes 38 (such as an operation system, an application software) from a storage device (such as a hard disk device 22A or an optical disk drive 22B) to the volatile RAM 32 such that the processor 12 can execute the program code 38 for the computer 10 to perform functions. When the computer 10 operates, a user can push some specific keys on the keyboard 28 to direct the computer 10 to enter into the STR status wherein an operation signal 27 corresponding to the action will be generated and transmitted to the processor 12. According to the essential program code of the BIOS 30, the processor 12 is told that the user commands the computer to enter the STR status and the computer 10 will stop supplying power to the processor 12, the video card 34, the chipset 14, and most devices and circuits of the peripherals 18, but only supplies power to the RAM 32 such that the RAM 32 can continuously store the loaded program code 38. The computer 10 then enters into the STR status. In the STR status, due to that the operations of the processor 12, the video card 34, the chipset 34, and most devices and circuits of the peripherals 18 are terminated, the power demands for the computer 10 will be largely reduced which is the objective of the STR. Corresponding to the specific operation signal 27 directing the computer to enter into the STR status, a plurality of signals related to wake-up events are stored in the BIOS 30. Generally, the action of pushing any key on the keyboard 28 or touching the pointing device 24 matches a wake-up event directing the computer 10 from being in the STR status to operating. In other words, by pushing any key on the keyboard 28 or touching the pointing device 24, the computer 10 can operate again by providing power to the processor 12, the chipset 14, the video card 34, and each device and circuit of the peripherals 18. Due to that power still supplies the volatile RAM 32 in the STR status for storing program code 38 continuously, when the computer 10 is relieved from the STR status, the processor 12 can directly execute the stored program code 38 in RAM 32 without a need to reload related program code from a storage device. Therefore, the computer 10 can quickly operate again after being relieved from the STR status.

Though, the STR process can make the prior art computer 10 stay in a low power cost condition and quickly resume operation, the computer 10 cannot apply the STR process in a total power-failure condition because in the STR status, the computer 10 still should supply power demands for the volatile RAM 32 by the external power source 42. Without any power supply, the volatile RAM 32 can no longer store the program code 38 wherein time will be wasted on turning on the computer 10 and loading the program code 38 from a storage device again. In other words, if some unexpected power-failure happens to the prior art computer 10, or no external power source is provided to supply the evolved desknote computer being moved from one place to another, the STR process still cannot be applied.

### SUMMARY OF INVENTION

It is therefore a primary objective of the claimed invention to provide a method and related computer being supplied with power from a battery for applying suspend to RAM (STR) during power failure so as to resume operations of the computer quickly after power failure to overcome the problem of the prior art.

A battery is provided in the present invention for specifically supplying power to the RAM in the STR status wherein even the power supplied from the external power source is off, the present invention computer can still enter into the STR status and store the program code by being supplied with power from the battery. The program code stored in the RAM can be directly applied to the present invention computer to resume operation without any need to restart the computer. The desknote computer evolved from the present invention can enter into the STR status while being moved from one place to another and quickly resumes operation after being supplied with power from another external power source again. The principle of the present invention can be applied to a UPS system wherein once the power from the external power source is off, the present invention computer can enter into the STR status such that data will not be lost due to power failure, and the computer can quickly resume operation after power is restored.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a prior art computer.

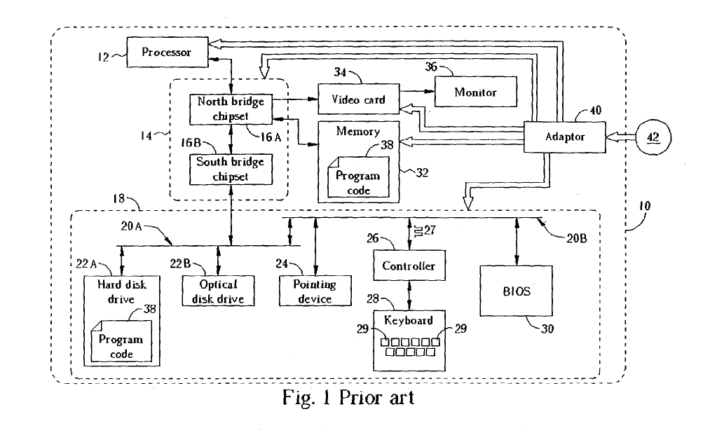

FIG. 2 is a functional block diagram of a present invention computer.

FIG. 3 is a power management process flowchart of the computer illustrated in FIG. 2.

### DETAILED DESCRIPTION

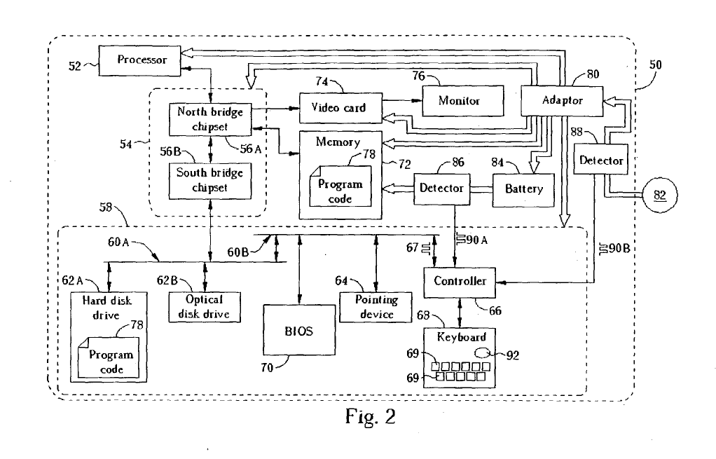

Please refer to FIG. 2. Illustrated in FIG. 2 is a functional block diagram of a present invention computer 50. The computer 50 comprises a processor 52, a chipset 54, a peripheral 58, a video card 74, a monitor 76, a volatile RAM 72, and an adaptor 80 wherein the adaptor 80 is applied to convert power supplied from an external power source 82 to one available for the computer 50 such as converting an AC current power from the external power source 82 to a DC current power. In order to practice the present invention computer 50, it is provided with a battery 84, a detector 86, and 88 for power detection.

Similar to the arrangement of the prior art computer 10, the processor 52 is applied to control operations of the computer 50. The processor 52 can exchange data with the video card 74, the RAM 72, and each device and circuit of the peripherals 58 through a north bridge chipset 56A, a south bridge chipset 56B, and a bus 60A and 60B. The video card 74 is applied to deal with image information and transfer the information to the monitor 76 for expressing the operational status of the computer 50.

The RAM 72 can load program code 78 from a storage device hard disk drive 62A, or an optical disk drive 62B provided in the peripherals 58 wherein the processor 52 can access and execute program code 78 stored in the RAM 72 to perform predetermined functions of the computer 50. Additionally, input devices such as a pointing device 64 (such as a mouse or a touch pad) and a keyboard having a plurality of keys 69 are provided in the peripherals 58. When a user pushes each of the keys 69, an action will be converted to an operation signal 67 by a controller 66, and transmitted through the chipset 54 to the processor 52 so that the processor 52 can operate according to commands of the user. Similarly, the pointing device 64 can be a mouse or a touch pad whose operation will be converted to a corresponding operation signal to the processor 52. A BIOS 70 in the peripherals 58 is applied to store essential program code related to operations of the peripherals 58. According to the program code, the processor 52 can access signals and data of each device and circuit of the peripherals 58.

A battery 84 is provided in the present invention computer 50 for supplying power for maintaining data stored in the volatile RAM 72, especially when the computer 50 is no longer supplied with power by the external power source 82. The detector 88 is applied to detect the power value of the adaptor 80 supplied from the external power source 82 for generating a corresponding detecting result 90B. The detector 86 is applied to detect the power value supplied from the battery 84 for generating a corresponding detecting result 90A. In a preferred embodiment of the present invention, the detecting results 90A and 90B will be transmitted to the controller 66 to generate a corresponding operation signal 67. In other words, detecting results of the detector 86 and 88 will be transmitted as an operation signal through the controller 66 to the chipset 54 and the processor 52 such that the computer 50 can apply the power management processes of the present invention according to the detecting results.

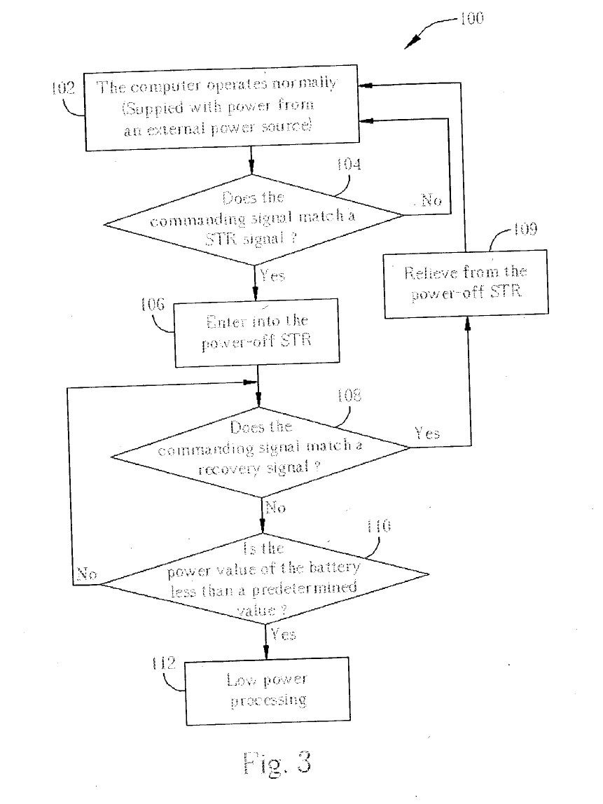

A main point of the present invention is that when the computer 50 stops receiving power from the external power source 82, the battery 84 can be applied to supply the power demand of the RAM 72 to maintain program code stored in it so that after the computer 50 is supplied with power from the external power source 82 again, the computer 50 can apply the program code stored in the RAM 72, and recover from the STR status to a normal operational condition. In order to distinguish from the prior art STR, the STR process supplied with power from the battery 84 is called “power-off STR”. Please refer to FIG. 3 and FIG. 2. Illustrated in FIG. 3 is a flowchart 100 of power management processes of the present invention computer 50 applied with the battery 84. The flowchart 100 is as follows:

Step 102: When the computer 50 operates normally, the external power source 82 will supply power to the computer 50 wherein program code 78 is loaded to the RAM 72 from the storage device, and the processor 52 will execute the program code stored in the RAM 72. In a preferred embodiment of the present invention, the computer 50 will unceasingly charge the battery 84 from the external power source 82.

Step 104: If the computer 50 detects that the operation signal 67 generated by the controller 66 matches a predetermined STR signal, go to step 106 for power-off STR; otherwise, maintain normal operations of the computer 50. In the present invention, the STR signal can be set up according to two kinds of embodiments. The first one is: predetermine some keys or keys combination on the keyboard 68 (like [ALT]+[F4]) as an operation signal representing an STR signal. Once a user pushes the specific keys or keys combination, the flowchart 100 will directly go on to step 106 for applying the present invention power-off STR. Another embodiment is: once the detecting results 90B of the detector 88 represents that the power supplied by the external power source 82 drops below a predetermined value, the controller 66 produces corresponding operational signal 67, predefined power-off STR. In other words, when the detector 88 detects that the power supplied from the external power source 82 drops below a predetermined value (such as the user removes the power cord between the external power source 82 and the computer 50 by accident, or unexpected power service failure), it represents that the power supplied from the external power source 82 cannot fulfill the power demands for the computer 50. The operation signal 67 will be generated by the controller 66 according to the detecting result 90B, and the flowchart 100 will go on to step 106 for power-off STR. Before entering into the STR status, setup of associated circuits must be done by the processor 52 and/or the chipset 54. Therefore, in the second embodiment of the present invention, when the detector 88 detects that no power is supplied from the external power source 82, the battery 84 will go on supplying power to the processor 52 and/or the chipset 54 such that the processor 52 and/or the chipset 54 can do some necessary setup for the computer 50 entering into the STR status. The processor 52 and/or the chipset 54 directing the computer 50 for entering the STR status can be taken as an STR control module. When the STR control module operates so that the computer 50 enters into the STR status, the battery 84 can supply mostly the power to the RAM 72 and stop supplying the processor 52 or related devices.

Step 106: Apply the power-off STR. When the operation signal 67 is determined matching the predetermined STR signal in step 104, the computer 50 will stop receiving power from the external power source 82 such that the processor 52, the video card 74, the chipset 54, the chipset 54, and most devices and circuits of the peripherals 58 will stop operating due to power failure. At the same time, the battery 84 will start to supply power to the RAM 72 to sustain the loaded program code 78. As mentioned above, the STR has been applied in a prior art. The present invention power-off STR can apply the existed techniques and processes of the present STR with aids of the battery 84 continuing to supply power from the external power source 82, to the RAM 72 during power failure.

More specifically, when the operation signal 67 matches a predetermined STR signal in step 104, the present invention can perform power-off STR according to two embodiments. The first embodiment is: while the power from the external power source 82 is still larger than a predetermined value representing that the power supplied from the external power source 82 can fully support the demands for the computer 50, the processor 52 which is still supplied from the external power source 82 can according to the essential program code stored in the BIOS 70 set up the wake-up event of the STR as a specific wake-up event, wherein only if the operation signal 67 matches a predetermined recovery signal can the computer be relieved from the STR. Next, the computer 50 will immediately switch the power source for the RAM 72 from the external power source 82 to the battery 84 such that the processor 52, the video card 74, and most of the devices and circuits of the peripherals 58 will stop operating due to power failure. Another embodiment is: when the power supplied from the external power source 82 is less than a predetermined value representing that the power supplied from the external power source 82 cannot fully support the demands for the computer 50, the computer 50 will switch the power source for the RAM 72 and the STR control module to the battery 84. After the STR control module directs the computer 50 to enter into the STR status, the processor 52, the video card 74, the chipset 54, and most of the devices and circuits of the peripherals 58 will stop operating due to power failure. The processor 52 which is supplied from the battery 84 can according to the essential program code stored in the BIOS 70 set up the wake-up event of the STR as a specific wake-up event wherein only if the operation signal 67 matches a predetermined recovery signal can the computer be relieved from the STR.

As mentioned above, in a prior art STR, several wake-up events (such as pushing any key on a keyboard or touching a pointing device) can relieve the computer from the STR status. The idea “relieve the computer from the power-off STR status by wake-up events” can be applied in the present invention. However, in the present invention, the wake-up events must be limited to some specific events such as pushing some specific keys or key combination on the keyboard. Since the specific point of the present invention power-off STR is to keep the STR status during power failure, if the power-off STR of the computer is easy to be relieved during power failure, the computer 50 cannot operate normally without enough power. So the present invention has to limit wake-up events on some specific events to avoid the situations in which a user just accidentally touches the pointing device or any key on the keyboard resulting in the computer 50 being relieved from the power-off STR. In the preferred embodiment of the present invention, a specific button 92 can be provided on the keyboard 68 which is different from normal letter keys and number keys and is specifically applied for the computer 50 to enter into/being relieved from the power-off STR status. When the computer 50 operates normally (step 102), push the specific button 92 for generating a operation signal 67 matching an STR signal such that the flowchart 100 will go on to step 106 wherein the computer 50 enters into the power-off STR status. When the user pushes the button 92 again (the user must be sure of the normal power supply from the external power source 82), the pushing action will match the recovery signal to relieve the computer 50 from the power-failure STR status.

Except for “pushing a specific button” as a wake-up event, the recovery signal can be determined by the detecting results 90B of the detector 88. When the detector 88 detects that the power supplied from the external power source 82 is larger than a predetermined value, an operation signal 67 generated by the controller 66 according to the detecting result 90B can act as a recovery signal. In other words, during power-off STR, when the detector 88 detects the power from the external power source 82 is larger than a predetermined value representing that the external power source 82 can supply power again, the computer 50 can be relieved from the power-off STR status and apply the external power source 82 for power supply. As mentioned above, in the present invention, the power-off STR can be a protection process wherein when power from the external power source 82 is unexpectedly cut off, the computer 50 can enter into the power-off STR status automatically (please refer to step 104). Accordingly, the present invention computer 50 can be relieved from the power-off STR status automatically back to operating again quickly.

Step 108: During power-off STR, when an operation signal 67 matches a predetermined recovery signal representing a wake-up event, the flowchart 100 will go on to step 109 to relieve the power-off STR status. As mentioned above, in the present invention, an operation signal matching a recovery signal can be generated by pushing a specific button or key, or the detecting results of the detector 88 when the external power source 82 resumes supplying power.

Step 109: The computer 50 is relieved from the power-off STR status. At this moment, the external power source 82 can supply power demands for the computer 50 so that the computer 50 will supply power to the processor 52, the chipset 54, the peripherals 58, the video card 74, and the RAM 72. Certainly, the battery 84 will no longer need to supply power to the RAM 72. In the preferred embodiment of the present invention, the computer 50 will charge the battery 84 through the adaptor 80 from the external power source 82. The computer 50 operates normally again, and the flowchart 100 will go back to step 102.

Step 110: From step 108 to this step, it represents that the computer is still not relieved from the power-off STR status. At this moment, the detector 86 will continue to detect the power value supplied from the battery 84 to the RAM 72 and generate a corresponding detecting result 90A being converted to a operation signal 67 by the controller 66 transmitted to the chipset 54. If the detecting result of the detector 86 represents that the power supplied from the battery 84 is larger than a predetermined value, the flowchart 100 will return to step 108. Alternatively, if the detector 86 detects that the power supplied from the battery 84 is less than a predetermined value, it represents that the power supplied from the battery 84 cannot support the demands for the RAM 72 to store data. The flowchart 100 will go on to step 112.

Step 112: Apply low power processing. From step 110 to this step, it represents that the power of the battery 84 is not enough to support the demands for the RAM 72. The computer 50 will generate some warning signals (such as a beep, or lights flashing on the keyboard 68) to notify the user that the power of the battery 84 can no longer support the power demands during power-off STR. The user should then find an available external power source 82 or the stored program code 78 in the RAM 72 will be lost, and the computer 50 has to restart for operating normally.

According to the discussion above, the present invention can be applied in two different ways. First, the present invention power-off STR can be a solution for a UPS system. When power supplied from the external power source 82 is suddenly cut off (such as if a power cord is removed or during a power service failure), the computer 50 can according to the detecting result of the detector 88 apply the power-off STR automatically (just like step 104) to supply power to the RAM 72 from the battery 84. When the power supplied from the external power source 82 resumes, the computer 50 can automatically be relieved from the power-off STR status and operate supplied with power from the external power source 82 (like step 106 and 108). Additionally, a desknote computer evolved from the present invention computer 50 can apply power-off STR while being moved. If a user carries the computer 50 from one place to another, he can apply power-off STR to the computer 50 by himself. While being moved from the first place to the second place, even without power supply from an external power source 82, the computer 50 can maintain functions of the RAM 72 supplied from the battery 84 and perform STR. After arriving at the second place, the user finds a new external power source 82 and connects it to the computer 50, the computer 50 can be relieved from the power-off STR status to operate again wherein the user need not restart the computer and reload application programs.

In the prior art computer with an external power source as the only power supply source, during normal operation or STR status, it is the external power source supplying power. If the external power source has been cut off, the prior art computer will no longer operate. On the contrary, the power-off STR disclosed in the present invention applies a battery to supply power for the computer to enter into the STR status during the external power source being cut off. After power supply from the external power source resumes, the computer of the present invention can resume operating quickly without a complicated restarting processes. This is more convenient for a user. Although the present notebook computers take AC current and power from a power storage device as the external power source, and switch to be supplied with power from the power storage device when the AC current is cut off, the arrangement cannot make the notebook computer enter into the STR status automatically after power failure wherein the power storage device still supplies power to the processor, the RAM, and each device and circuit of the peripherals. Thus, the power storage device requires a better power capacity with larger volume, weight, and cost. In contrast, the present invention battery should only supply power to the RAM whose power demand is much less such that the volume, weight, and cost of the battery can be reduced. The volume, weight, and cost of a desknote computer evolved from the present invention computer 50 can be therefore reduced. The desknote computer being moved can apply the power-off STR and uses an external power source to quickly resume operation. In a present notebook computer, a power storage device is usually provided with cells having 16 Li batteries, with each cell supplying 20000 mAh. In a preferred embodiment of the present invention, it takes only one cell provided in the battery 84 of the computer 50 to supply the power-off STR about half an hour. When the computer 50 operates normally, the adaptor 80 can convert power of the external power source 82 a current power with 5, 3.3, 2.5, or 1.25 V supplying each circuit and device of the computer 50, and a power with 4.2V charging the battery 84 wherein the power demand can be supplied from the battery 84 for the computer applying the power-off STR process. The battery 84 can be a replaceable battery that can be removed from or plugged into the computer 50. To sum up, the present invention can be a solution for a UPS system, and the desknote using the present invention can quickly resume operation after being moved.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method applied in a computer for controlling operations of the computer during power failure, the computer being connected to an external power source, the computer comprising:
a volatile RAM for storing program code;
a processor electrically connected to the RAM for executing the program code stored in the RAM so as to control the operations of the computer;
a battery electrically connected to the RAM for supplying power to the RAM but not to the processor;
the method comprising the battery providing power to the RAM but not to the processor for sustaining the program code when the external power source stops supplying power to the processor and the RAM.

2. The method of claim 1 wherein the computer further comprises a storage device for storing the program code in a non-volatile manner, the method further comprising the processor reading the program code from the storage device and loading the program code into the RAM.

3. The method of claim 1 further comprising when the computer shuts down, stopping supplying the RAM with power from the battery and the external power source.

4. The method of claim 1 wherein the computer further comprises an input device for receiving an input command and generating a corresponding operation signal for controlling operations of the computer by the processor according to the operation signal; the method further comprising the external power source resupplying power to the RAM, and the processor after the external power source stops supplying power to the computer and the input device receives an input command and generates an operation signal which matches a predetermined recovery signal so that the processor is capable of accessing the program code stored in the RAM again.

5. The method of claim 1 wherein the computer further comprises an input device for receiving an input command and generating a corresponding operation signal for controlling operations of the computer by the processor according to the operation signal; the method further comprising stopping supplying the computer with power from the external power source when the input device receives an input command and generates a corresponding operation signal which matches a predetermined STR (Suspend To RAM) signal so as to stop operations of the processor.

6. The method of claim 1 wherein the computer stopping receiving power from the external power source when the power provided by the external power source drops below a predetermined value so as to stop operations of the processor.

7. The method of claim 1 further comprising after the external power source stops supplying the computer with power, if the power provided by the external power source increases over a predetermined value, the computer receiving power from the external power source again and the external power source resupplying power to the RAM and the processor so that the processor is capable of accessing the program code stored in the RAM again.

8. The method of claim 1 further comprising when the battery supplies the RAM with power, the computer generating a warning signal if the power of the battery is less than a predetermined value.

9. The method of claim 1 further comprising when the computer is supplied with power from the external power source, supplying the RAM with power from the external power source for storing the program code.

10. The method of claim 9 further comprising when the RAM is supplied with power from the external power source, stopping supplying the RAM with power from the battery.

11. The method of claim 1 further comprising when the computer is supplied with power from the external power source, charging the battery with the external power source.

12. A computer comprising:
a volatile RAM for storing program code;
a processor electrically connected to the RAM for accessing the program code stored in the RAM so as to control operations of the computer; and
a battery electrically connected to the RAM for supplying power to the RAM but not to the processor such that when the processor stops operating due to a power failure from the external power source to the computer, the battery is capable of supplying power to the RAM for sustaining the program code continuously.

13. The computer of claim 12 further comprising a storage device for storing the program code in a non-volatile manner, the processor being capable of reading the program code from the storage device and loading the RAM with the program code.

14. The computer of claim 12 further comprising an input device for receiving a command and generating a corresponding operation signal for controlling operations of the computer by the processor according to the operation signal wherein when the input device receives a command and generates a corresponding operation signal which matches a predetermined STR (suspend to RAM) signal, the computer is no longer capable of being supplied with power from the external power source so as to stop operations of the processor.

15. A computer being supplied with power from an external power source, the computer comprising:
a detector for detecting the power supplied by the external power source;
a volatile RAM for storing program code;
a processor electrically connected to the RAM for executing the program code stored in the RAM so as to control operations of the computer;
a STR controlling module for controlling the computer to sustain data in the RAM; and
a battery for supplying the RAM and the processor with power;
wherein when the detector detects that the power provided by the external power source is less than a predetermined value, power is supplied to the STR control module and the RAM by the battery for directing the computer to enter into the STR status to sustain the program code in the RAM, and when the computer enters into the STR status, power is no longer supplied to the processor and the STA control module by the battery.

16. The computer of claim 15 wherein when the computer enters into the STR status, if the detector detects that the power provided by the external power source increases over a predetermined value, the processor and the RAM are supplied with power from the external power source, and power is no longer supplied to the RAM by the battery.
